(19) United States
(12) Patent Application Publication
(10) Pub. No.: US 2025/0384513 A1
(43) Pub. Date: Dec. 18, 2025

(54) DISTRIBUTED LEDGER NETWORK ARCHITECTURE

(71) Applicant: Michael Shumikhin, Miami, FL (US)

(72) Inventor: Michael Shumikhin, Miami, FL (US)

(21) Appl. No.: 18/746,321

(22) Filed: Jun. 18, 2024

(51) Int. Cl. G06Q 50/34; G06Q 20/36; G06Q 20/38; G06Q 20/40

(52) U.S. Cl. CPC G06Q 50/34; G06Q 20/3676; G06Q 20/389; G06Q 20/405

(57) ABSTRACT

Techniques of the disclosure herein relate to a gambling architecture that may occur at least in part on a distributed ledger network (i.e., blockchain). In some instances, a gambling system or method may receive from a user (e.g., a bettor) a wager placed on a game. A smart contract stored on a node of a distributed ledger network may determine a return amount by sending a request to an off-network application (e.g., an oracle), which may return a value that is used to determine a multiplier (e.g., by mapping the value to a function/set of possible return multipliers). Based on the multiplier and the wager, the return amount may be determined. At or before the terms of the smart contract execute, game characteristics of the first game may display the return amount to the user, and a currency balance associated with the user may be updated.

### BACKGROUND

Distributed ledger networks present numerous benefits to myriad industries. Due at least in part to their decentralized nature, transparency, immutability, and ability to interface with smart contracts, distributed ledger networks have become popular. However, distributed ledger networks can be computationally expensive and may be limited in their ability to reflect real-world, complex situations.

### BRIEF DESCRIPTION OF THE DRAWINGS

Features of the present disclosure, its nature and various advantages, will be more apparent upon consideration of the following detailed description, taken in conjunction with the accompanying drawings. In the figures, the leftmost digit(s) of a reference number identifies the figure in which the reference number first appears. The use of the same reference numbers in different figures indicates similar or identical items or features. The drawings are not to scale.

FIG. 1 depicts an example environment associated with one or more user(s) interacting with an improved distributed ledger network architecture, according to an embodiment described herein.

FIG. 2 depicts a flow diagram of an example process for a user placing a wager and receiving a return in associated with an improved distributed ledger network architecture, according to an embodiment described herein.

FIGS. 3A and 3B depict a pictorial flow diagram of an example process for a user interacting with an improved distributed ledger network architecture, according to an embodiment described herein.

FIG. 4 depicts a block diagram of an example system for implementing various techniques described herein.

FIG. 5 depicts a flow diagram of an example process for artificial intelligence utilization in association with an improved distributed ledger network architecture, according to an embodiment described herein.

FIGS. 6A and 6B illustrate a flow diagram of an example process for a user interacting with an improved distributed ledger network architecture, according to an embodiment described herein.

FIGS. 7A and 7B illustrate a flow diagram of an example process for a user interacting with an improved distributed ledger network architecture, according to an embodiment described herein.

### DETAILED DESCRIPTION

As discussed briefly above, distributed ledger networks present numerous benefits to myriad industries. Due at least in part to their decentralization and immutability, distributed ledger networks are far less vulnerable to cyberattacks and malicious actors than a centralized bank or financial institution may be, for example. Similarly, distributed ledger networks have created a platform for innovation, enabling the development of business models, cryptocurrencies, smart contracts, and decentralized finance, among others. In the context of gambling, distributed ledger networks may interface with cryptocurrencies, smart contracts, and/or various off-network applications (e.g., oracles). Despite their benefits, use of distributed ledger networks for gambling is limited at least because of the inherent computational expense of transactions on the network, a lack of scalability across multiple machines/operators, a dependency on volatile and unregulated cryptocurrencies, and an impaired user experience due to unverifiable algorithms and less intuitive or user-friendly interactions.

Aspects of the disclosure herein relate to an online gambling architecture using a distributed ledger network (e.g., blockchain) that substantially limits the computational expense of transactions on the network, is scalable across many machines and/or operators (e.g., casinos), may be integrated seamlessly with any one or more cryptocurrencies of a user's choice, and improves the user experience of online gambling by ensuring fluid and responsive interactions, mathematically verifiable algorithms, and cryptographically secure activities. More specifically, immutable, automatically executing smart contracts comprising game rules/logic and/or payout rules/logic may be published ahead of time and stored on nodes of a distributed ledger network. In response to a user's wager transaction interacting with the smart contract, the contract may call on an off-network (i.e., offchain) oracle to determine a random value, which may be mapped to a return multiplier on a function/set of return/payout possibilities. The return multiplier and user's wager may then be used to determine the user's payout/return amount, and the user's currency balance may be updated accordingly. Using pre-published smart contracts and an off-network oracle to determine a return amount reduces the memory intensive nature of making calculations on the distributed ledger network, which in turn increases the responsiveness of the platform and improves the user experience by limiting loading/down time. Additionally, by executing the mathematical heavy-lifting off-network irrespective of the game theme or design, the user-experience can be skinned or themed in myriad different ways or may be displayed to a user in various platforms or formats. Further, by using accessible and verifiable distributed ledger network nodes, the user can be statistically certain that their online experience mirrors that of a real-life, in person casino. For the sake of clarity and not limitation, it should be noted that “wager” and “wager transaction” may be used interchangeably throughout to describe a user interaction with a gambling application/interface that may comprise a risk/stake/bet (e.g., dollars, Ethereum tokens, etc.) and confirmation/placement of the risk/stake/bet on a determined game or set of rules.

Additionally or alternatively, executing the calculations prior to or simultaneously with performing the gambling experience (e.g., dealing or revealing over the cards, spinning the slots, etc.) and then rendering the user experience to reflect the calculations increases the flexibility of what game format may be used and decreases the on-network memory required to process all of the information associated with a gambling event/instance. In other words, when a user places a wager transaction, the on-network smart contract may execute the determination of the return amount in the background, and the user experience/game characteristics may be constructed to reflect the return amount, thereby allowing an operator to display the result in any number of formats/designs and improving the overall efficiency of a gambling event/instance.

More specifically, in some examples, one or more processors associated with a system may receive, from a user device (e.g., a slot machine, a smartphone application, a web-based application, etc.), a wager transaction placed to interact with a previously published smart contract associated with a game theme (e.g., slots, blackjack, over/under sports, etc.) where the wager corresponds to an amount of currency (e.g., Ethereum, Bitcoin, Tether, cash/credit, etc.) associated with a digital wallet of a user of the user device. In some examples, a user may associate a cryptocurrency or other digital wallet address with the system prior to or simultaneously with placing the wager transaction on the user device. In some examples, the system may query the distributed ledger network to determine whether the currency balance associated with the user's wallet address meets or exceeds the wager amount. In other words, the system may first confirm that the balance associated with the wallet address is sufficient to cover the wager placed by the user. The system may then interact, based at least in part on the wager transaction and the set of rules defined in the previously published smart contract associated with the game theme, with the smart contract stored on a node of a distributed ledger network (e.g., blockchain), wherein the set of rules indicate how return/payout amounts are to be determined. For example, based on the wager amount and the rules that govern the game theme (e.g., the odds and/or payout possibilities associated with the game, result of rolling one or more dice or displaying a hand of cards, etc.) the wager transaction may interact with a previously published smart contract may be generated on a node of the distributed ledger network. In some examples, the system and/or method may determine, prior to game execution of the game theme, a return amount based at least in part on terms defined by the smart contract. Determining a return amount may improve performance of the system, the scalability across multiple machines and/or operators, and the user experience by ensuring fluid and responsive interactions. For example, due to the computational expense of making calculations on a distributed ledger network (i.e., because of their distributed nature and consensus requirements), conventional techniques of using distributed ledger networks in the context of gambling are difficult to scale across multiple machines and are typically slow and unresponsive, interrupting the user experience. Determining a return amount in the background of the system, prior to game execution, decreases the overall cost of the wager and experience because the game characteristics (e.g., graphics) are not directly reliant on or associated with the determination of the return amount. That is, the techniques described herein may occur independent of the specific gambling machine or instance (e.g., user application, device, etc.), facilitating an improved performance of the determination of the return amount and allowing an operator to apply the techniques described to myriad gambling formats or game themes.

As someone with ordinary skill in the art will appreciate, smart contracts are independently verifiable, immutable agreements that automatically execute terms stored in the contract if and when the conditions/logic stored in the contract are satisfied. That is, smart contracts typically store, verify, and self-execute one or more rules (for the sake of clarity, “rules” will be used throughout to denote terms, conditions, logic, instructions etc.) that may be stored in the pre-published smart contract. For the sake of simplicity and not limitation, “generate” and “interact,” may be used interchangeably throughout to describe a communication, association, and/or action that one or more of the techniques described herein may take to interface with a node of a distributed ledger network or with a smart contract that may be stored on the node. The rules stored in the smart contract that is interacted with and/or generated based at least in part on the wager may comprise sending a request for a value (e.g., random, result) to an off-network application (e.g., oracle). The request may be associated with a request identifier such that the node of the distributed ledger network can successfully return the value to the individual or system which interacted with the stored smart contract. In some examples, the off-network application may be a verifiable random function (VRF), a web-based or offline data source, a legacy system, an aggregator or computer capable of advanced aggregation, analysis, and/or computing, application programming interface, etc. The off-network application may independently verify the terms of the smart contract before acting on the request. The terms of the smart contract may then receive, from the off-network application, a value (e.g., random). The value may be associated with the request identifier. The terms of the smart contract may additionally determine a multiplier (e.g., return multiplier) based at least in part on mapping the value to a function of return possibilities. Such a function of return possibilities may be a piecewise linear function associated with the rules of the game theme that constitutes all or some of the potential payout combinations and/or situations. As discussed in more detail below, the function of return possibilities may be a normalized distribution of returns or other function of return possibilities mapped according to their frequency. In some examples, a house edge may be created by limiting the function of return possibilities to a specific range or by tweaking the frequencies associated with each return possibility, thus ensuring that the operator (e.g., casino) it at a statistical advantage.

In some examples, the terms defined by the smart contract may further determine, based at least in part on the return multiplier and the wager placed by the user, the return amount. In such examples, the return multiplier may be applied to the wager amount to determine the return to the player. For the sake of clarify and by way of example and not limitation, a user may wager $5.00, and the terms of the smart contract may determine a return multiplier of 0.2×, meaning the return amount back to the user would be $1.00. In some examples, the return amount may then be displayed to the user of the user device. For example, the system may cause, based at least in part on the game theme, rendering of a set of game characteristics including at least the return amount on the first user device. With the return amount determined by the terms defined by the smart contract, the system may display the return amount to the user along with any one or more game characteristics to improve the user experience (e.g., lights, graphics, animations, other visual effects, and/or sounds, music, etc.) associated with the game. By way of example and not limitation, in the context of a slot machine, the machine may display the return amount to the user overlaid on the reels with accompanying sound alerts and/or visual effects. In at least some examples, causing the rendering of the game characteristics occurs off-network such that memory use by the distributed ledger network is reduced and/or minimized. In such examples, the distributed ledger network may only be used for the ‘backend’ techniques, meaning the execution of the terms defined by the smart contract. Such functionality thereby reduces the computational expense required by the distributed ledger network, which in turn improves the usability and reactiveness of the system and user device by decreasing latency and load/buffer times. Causing rendering of the game characteristics off-network may additionally or alternatively improve the scalability of the techniques described herein by allowing the methods and processes to be applied to myriad game themes and/or formats. For example, rendering the game characteristics off-network may mean that the techniques described herein can be applied to any gambling environment/format that relies at least in part on a determination of a return amount to be paid out to the user. In such examples, in other words, the return amount may be securely and verifiably determined on a distributed ledger network separate and distinct from the gambling format and/or game characteristics, thereby allowing the techniques herein to be applied to any gambling format and/or game that returns an amount of currency to a user and displays that amount with any one or more visual, audio, or other sensory characteristics.

In some examples, the terms defined by the smart contract may be based at least in part on parsing the set of rules associated with the first game theme to remove data/instructions/information unnecessary for the determination of the return amount. For example, the rules that govern or define the operation of a gambling format/game may be parsed through to remove everything that is not directly or tangentially related to determining the return amount. In such an example, the determination of the return amount as defined by the terms in the smart contract may be the only data that resides on or is executed by the node on which the smart contract is stored. In other examples, the terms defined by the smart contract may not be associated with or sent to a node of the distribute ledger network without first being parsed/simplified/optimized to avoid unnecessary or redundant data being stored on the distributed ledger network. In yet other examples, a machine learning model may be used to parse and/or update the terms defined by the smart contract. In such examples, a machine learning model configured to generate as output at least a portion of data comprising the smart contract may be generated. Additionally or alternatively, feedback data may be received (e.g., from the machine learning model) that may be indicative of one or more performance metrics of the smart contract (e.g., latency, efficiency, convolution, etc.). A training dataset may be generated from the feedback data, and the machine learning model may then be trained utilizing the training dataset such that a trained machine learning model is generated. In some examples, an updated smart contract to be stored on a node of the distributed ledger network may be determined utilizing the trained machine learning model.

In other examples, linear programming techniques may be used to parse through, update, and/or optimize the terms defined by the smart contract. In other words, the terms defined by the smart contract may be based at least in part on finding optimal on-network parameters for the game smart contracts using linear programming techniques. For example, the rules that govern or define the operation of a gambling format/game may be parsed through, simplified, and/or optimized to determine the return amount more efficiently and/or to reduce the overall and on-network computational expense. In some examples, the rules that define the determination of the return amount as defined by the terms in the smart contract may be the only data that resides on or is executed by the node on which the smart contract is stored. In other examples, the rules defined by the smart contract may not be associated with or sent to a node of the distribute ledger network without first being optimized to avoid unnecessary or redundant data being stored on the distributed ledger network. Linear programming techniques may be used to find optimal, non-redundant on-network parameters for the game smart contracts. In some examples, such linear programming techniques may be constrained or otherwise clarified based on one or more predetermined (e.g., by a user or operator, an ML model as described herein, etc.) conditions or constraints (e.g., volatility, multipliers, multiplier frequencies or percentages, etc.).

In some examples, based at least in part on the return amount determination, a currency balance associated with the digital wallet of the user of the user device may be updated. In such examples, the return amount may be added to or subtracted from the balance associated with the wallet address of the user. In some examples, updating the balance of the user's wallet address may comprise minting (i.e., creating, adding) and/or burning (i.e., deleting, destroying) cryptocurrency tokens and/or other currency coins to reflect an updated balance with the return amount added to or subtracted from the wallet address associated with the user.

The techniques described herein provide an improved distributed ledger network that may be applied to myriad gambling applications. Those with ordinary skill in the art will appreciate that the techniques described herein are not limited to gambling formats reliant on randomness or chance, and may be applied to sporting events or races, card games, application- and/or web-based games, lotteries, bingo, prize-pool related raffles, drawings, or competitions, fantasy sports, arcades and skill games, financial betting (e.g., spread betting), and so on. It should be noted that gambling is not currently legal in all jurisdictions. As such, those applying or considering applying the techniques discussed herein would be behooved to first check the gambling laws/rules in their jurisdiction.

### Example System

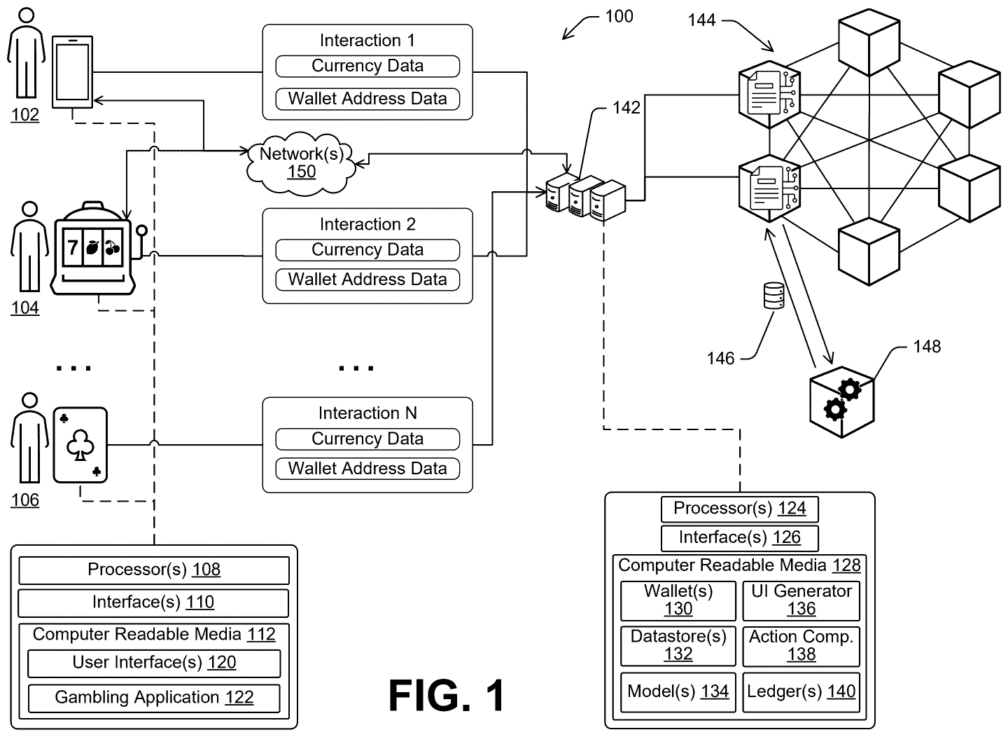

FIG. 1 depicts an example environment 100 associated with one or more user(s) interacting with an improved distributed ledger network architecture, according to an embodiment described herein. The environment may comprise one or more users associated with one or more user devices. In the depicted environment, a first user 102 may be associated with a first user device, a second user 104 may be associated with a second user device, an Nth user 106 may be associated with an Nth user device, and so on, where each user device may be the same or different and may each be associated with a same or different gambling theme or format (e.g., smart phone or tablet application, slot machine, black jack or other card-based format, etc.). Individual user devices may include one or more components such as one or more processors 108, one or more network interfaces 110, and/or computer-readable media (CRM 112). The user device may also be configured to include displays, which may be configured to present graphical user interfaces or other visual characteristics. In some examples, the displays can output images, videos, lights, animations, or the like via such graphical user interfaces. The user device may also include speakers, which may be configured to output audio, such as audio associated with a certain game theme, format, or characteristic.

The CRM 112 may include one or more applications or other components. For example, the one or more applications or other components can include one or more user interface(s) 120 and/or gambling applications 122. The applications or other components may be configured to execute in the foreground and background of the user device, and/or may be configured to communicate with one or more remote computing device(s) 142 which may be configured to communicate with a distributed ledger network 144. For example, the gambling application 122 may be configured to execute in the foreground when a user is actively engaged in one or more of the functionalities of the gambling application 122. In other examples, the gambling application(s) 122 may be configured to execute in the background when a user is not actively engaged in one or more of the functionalities, but the gambling application 122 is still “open” and is capable of communicating with other applications on the user device and/or with the remote computing device(s) 142 associated with the gambling application(s) 122. The gambling application 122, running in the background, may be caused to be displayed in the foreground in response to selection of certain functionality on one or more applications utilized by the user device. In some such examples, the gambling application 122 can transition to the foreground to perform content-related operations or can remain in the background and gambling operations can be performed without the gambling application 122 transitioning to the foreground. Additionally or alternatively the gambling application 122 may communicate (e.g., send or receive data associated with a wager) with the one or more computing device(s) 142 and/or the distributed ledger network 144. It should be understood that the user interfaces 120 described herein may include the gambling application 122 and may include one or more other user interfaces as described herein. It should also be understood that the gambling application(s) 122 or the functionality associated therewith can be integrated with other applications, such as third-party applications. The gambling application 122 may be downloaded on or otherwise be made available on a user device for a given user. The gambling application 122 may be associated with remote computing device(s) 142, which may be remote from the user device.

The gambling application 122 may be configured to display information and provide functionality for selecting and outputting gambling content such as wagers, applications/services, themes, payouts/returns, etc. When a user interacts with the gambling application 122 on a user device, for example, data representing those interactions may be generated and may be sent to the remote computing device(s) 142 for performing one or more actions. As illustrated in FIG. 1, currency data and/or wallet address data may be sent from any one or more of the user devices to the remote computing device(s) 142. Currency data may comprise a specific currency format (e.g., cryptocurrency like Ethereum, USDT, USDC, Bitcoin, or fiat currency like U.S. Dollars, etc.) and/or a currency amount/quantity. By way of example and not limitation, currency data may comprise a wager of 3.0 ETH tokens placed on a slot machine by the second user 104. Wallet address data may comprise a wallet address (e.g., location, identification number, etc.) associated with a user of the user device. Such a wallet address may be publicly available/accessible by a node of a distributed ledger network 144. FIG. 1 shows the flow of data and information to or from the first user device, second user device, and third user device as currency data and wallet address data for Interaction 1, Interaction 2, and Interaction N, with N representing any number of interactions. It should be understood that the flow of data may include currency data and wallet address data, or one of currency data or wallet address data.

The remote computing device(s) 142, which can be associated with one or more user devices, such as server computing devices or operator applications, may include components such as one or more processors 124, one or more network interfaces 126, and/or CRM 128. The CRM 128 may include one or more components such as, for example, one or more accounts 130, datastore(s) 132, one or more models 134 (which may be described as artificial intelligence or machine learning models), a user interface (UI) generator 136, an action component 138, and/or one or more ledgers 140. These components will be described below by way of example.

In at least one example, the remote computing device(s) 142 can expose functionality and/or services to or from the user device(s) via the one or more APIs, thereby enabling functionality and/or services described herein to be integrated into various functional components of the example environment 100. The API(s), which can be associated with the remote computing device(s) 142 can expose functionality described herein and/or avail content services to various functional components associated with the example environment 100. At least one of the API(s) can be a private API, thereby availing services and/or functionalities to functional components (e.g., applications, etc.) that are developed internally (e.g., by developers associated with the gambling service or with a casino, chain of casinos, or similar operator of a gambling service). At least one of the API(s) can be an open or public API, which is a publicly available API that provides third-party developers (e.g., gambling service providers or platforms) with programmatic access to a proprietary software application or web service of the gambling service. That is, the open or public API(s) can enable functionality and/or services of the gambling service to be integrated into one or more applications on one or more user device(s). The API(s) can include sets of requirements that govern how applications, or other functional components can interact with one another. In examples, the API(s) may allow for integration of third-party application systems with the remote computing device(s) 142 for the purposes of receiving and/or sending data associated with use of the gambling application. In at least some examples, the API(s) may be associated with, or have access to, a game NFT directory, retrievable database, or remote service, as discussed in more detail below.

In some examples, the remote computing device(s) 142 are configured to communicate with the distributed ledger network 144 to send and/or receive data associated with one or more gambling application(s) 122 and to interpret, analyze, compute, or otherwise use or translate the data or information received from the distributed ledger network 144 (e.g., a random value, a result of a sports game) and pass the result (e.g., the return amount) to one or more of the user device(s). By way of example and not limitation, the remote computing device(s) 142 may generate, based on a user placing a wager on a game theme (e.g., $5.00 wager on a slot machine) at a first user device, a smart contract to be stored on a node of the distributed ledger network 144, or may generate the terms to be defined by a smart contract that is already stored on the node of the distributed ledger network 144. As discussed in more detail below, the remote computing device(s) 142 may, after receiving data/information (e.g., return amount) from the executed smart contract, communicate that data/information back to the user via network(s) 150 to the gambling application 122 on the first user device.

In some examples, the remote computing device(s) 142 can provide third-party entities with a software developer kit (“SDK”) that may utilize functionality exposed by the API(s). The SDK can include software development tools that allow a third-party developer (i.e., a developer that is separate from the remote computing device(s) 142 or gambling service) to include functionality and/or avail services as described herein. The SDK and/or the API(s) may include one or more libraries, programming code, executables, other utilities, and documentation that allows a developer or operator to directly include functionality and/or avail services described herein within an application.

The datastore(s) 132 can store, among other types of data, user profiles (which may include the accounts 130). For instance, a user profile of a user can store interactions with the gambling application, payment data associated with payment instrument(s) or user account(s) of a user, and/or a currency wallet address associated with the user. In some examples, an account maintained by the remote computing device(s) 142 on behalf of the user can be mapped to, or otherwise associated with, the user profile. In some examples, a user profile can include historical group data, geographic data, user preferences, subject matter preferences, transaction data, contacts data, social relationship data, metadata tag data, interactions with gambling operators or services, and other information associated with use of the gambling application described herein. This data may be historical data and/or prior interactions. In at least some examples, the datastore(s) 132 may store data or information that does not identify the user associated with the user device. In such examples, a user may leverage the anonymity of the distributed ledger network 144 and the datastore(s) 132 may therefore be limited or restricted from collecting/storing personally identifying or sensitive data information. For example, the datastore(s) 132 may only store user preferences associated with the user device but may not require a user of the user device to log into an account or otherwise divulge username data, password data, or otherwise that may directly or indirectly tie the use of the user device to the user. In such examples, the datastore(s) 132 may store wallet address data associated with a user of a user device without requiring a user to log in or otherwise divulge personally-identifying information.

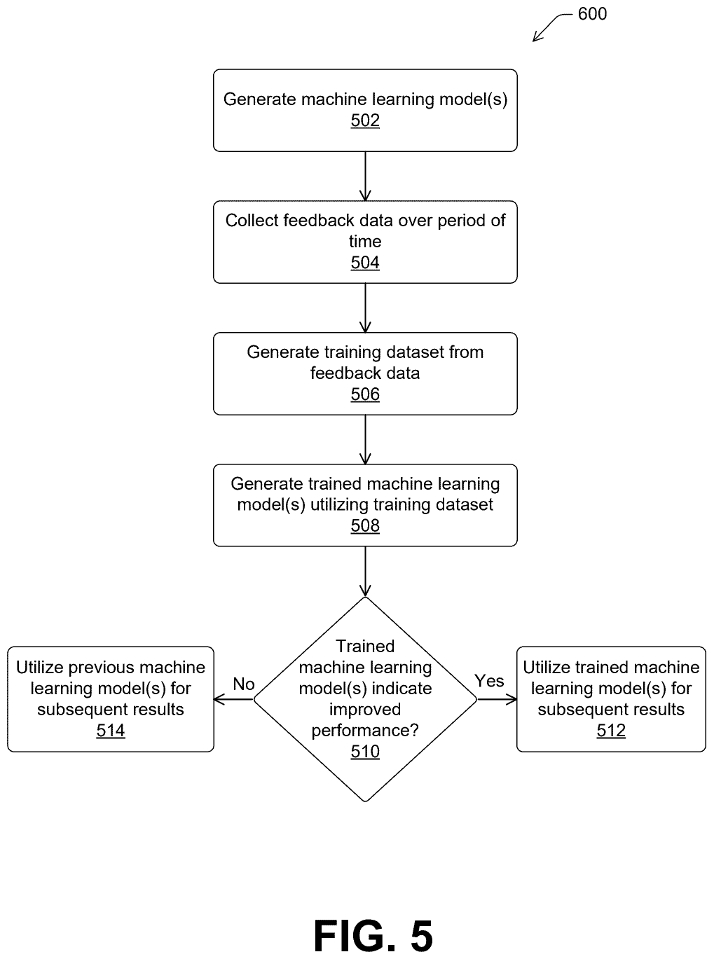

The models 134 may be utilized to receive interaction data from any given gambling application 122 or remote computing device(s) 142 and to provide the results of the models 134 to the action component 138 for determining one or more actions to take based on the interaction data. For example, the models 134 may be configured to determine if a user interaction with the gambling application 122 is one of a first threshold number of interactions. For example, the models 134 may be trained to set a threshold number of interactions for one or more purposes. The models 134 may also be configured to set one or more other conditions such as a geographic area associated with a user device, a gambling format/game, a specific casino or operator, etc. In at least some examples, the models 134 may be responsible for parsing and/or updating the terms of the smart contract to reduce unnecessary information for the determination of the return amount as described in more detail below with regard to FIG. 5. In such examples, the model(s) 134 may generate and/or be based at least in part on a machine learning model that is configured to generate as output at least a portion of data comprising the smart contract. The model(s) 134 (e.g., machine learning model) may train on a training dataset (e.g., existing on a local or remote datastore, generated, or a combination thereof) and may as a result return or determine a trained model (e.g., machine learned model). Based at least in part on the trained model, an updated smart contract to be stored in or associated with a node of the distributed ledger network may be determined. In such an example, the updated smart contract may be a streamlined, simplified, or otherwise parsed set of terms and data to reduce the memory use or otherwise reduce the computational burden on the distributed ledger network 144.

In other examples, the model(s) 134 may be configured to utilize the user interaction data to determine which user profile(s) and/or user device(s) were the last in time to interact with a certain game or format. The model(s) 134 may identify the user profiles and/or user device(s) that have most recently consumed certain games or formats and the action component 138 may perform one or more actions based on that determination. Example actions may include sending a recommendation to create an association between the user profiles that most recently played the game or format, sending a recommendation to play similar or related games or formats, sending a recommendation to play similar games or formats that the other user profiles or user devices are associated with, and the like. Additionally, interaction data may be aggregated over time to determine how many times and/or how frequently one or more user(s) interact with given game or format. In these and other examples, the remote computing device(s) 142 may be configured to communicate with a third-party system, device, or application to acquire data or information, user interface elements, return/payout functions or other math calculations, and/or any other data described herein to be utilized based on the results from the model(s) 134 and/or the action component 138, and/or the user interface generator 136. In some examples, the action component 138 may convert a first currency associated with the wager into a second currency. By way of example and not limitation, a user may place a wager of 5.0 Tether, but may wish to convert that currency into the corresponding amount of ETH prior to executing the game/wager. The ledger 140 and/or action component 138 may do so prior to generating a smart contract. Additionally or alternatively, the user may place a wager in USD Coins, for example, but may wish to receive their return amount in Binance Coin or ETH. The computing device(s) 142 may execute such a conversion before or after the smart contract executes and the return amount is determined and distributed to the user.

Based on some or all of the determinations described herein, the user interface generator 136 may generate user interface elements that are associated with the gambling application 122, payouts/returns, recommendations, card tables or slot machines, actions, etc. described above. These personalized user interface elements may be provided to the gambling application 122 for display on the user device(s) in question. By way of example and not limitation, the UI generator 136 may receive data and/or information from the distributed ledger network 144, interpret, analyze, calculate, or otherwise use or manipulate the data and/or information prior to sending it to the user device(s) for display to the user. In some examples, the UI generator 136 may cause the rendering of the set of game characteristics (e.g., visual, auditory, etc.) associated with the game theme/format which may include the return amount, as discussed in more detail below.

In some examples, the user device(s) may be configured to communicate with the distributed ledger network 144 without an intermediary or other service (e.g., remote computing device(s) 142). In some examples, the remote computing device(s) 142 may be configured to communicate with one or more node(s) of the distributed ledger network 144. In such examples, the remote computing device(s) may receive interaction data from one or more user device(s) and may generate a smart contract to be stored on a node of the distributed ledger network 144 according to the techniques described herein. For example, the remote computing device(s) 142 may, upon receipt of a wager placed by a user, initiate the generation of a smart contract, wherein the rules defined by the smart contract are based at least in part on the wager (and, e.g., the user's wallet address data) and the game format (e.g., slots, blackjack, fantasy sports, over/under sports wager, etc.). The rules defined by the smart contract stored on node of the distributed ledger network may send a request to an off-network application 148 for a random value or other data/information 146 pertinent to the wager on which the rules of the smart contract are at least partially based. The off-network application 148, sometimes referred to as an “oracle” may be a data source, algorithm, service, entity, or other infrastructure element designed to support distributed ledger network 144 applications capable of interfacing with real-world events, interoperating with legacy systems, or otherwise allowing off-network applications to obtain data/information 146 external to the distributed ledger network 144. By way of example and not limitation, a weather oracle may report daily rainfall, and an insurance-related smart contract may automatically trigger/execute a payout rule or term if and when the daily rainfall reported by the weather oracle reaches a threshold rainfall. As a more concrete example in the context of gambling, the rules defined by the smart contract may receive data/information 146 from sports data oracle that monitors the results of a sports competition (e.g., a winner, total points scored, a point spread, individual player stats, etc.) and may execute one or more payout functions to one or more users, user devices, and/or wallet addresses based at least in part on the data/information 146 provided by the sports data oracle and the wager(s) placed.

In yet other examples, a verifiable random oracle (VRF) may provide a random value in response to a request by the smart contract. The random value may be determined by the VRF along with a cryptographic proof of how the value was determined, thereby ensuring provably fair and verifiable randomness to the distributed ledger network 144 and to the user. In some examples, the cryptographic proof generated by the VRF may be published and verified on a separate node of the distributed ledger network 144. In such examples, due to the immutability and consensus-required nature of distributed ledger networks 144, the user can rest assured that the result (e.g., the random value and/or the return amount) has not been, and cannot be, tampered with or manipulated. Further, the user can be sure that the VRF determined the random value using a verifiably fair and provably random function, which thereby increases user trust and enhances the user experience.

It should be understood that any one or more off-network applications 148 may be used in conjunction with any one or more other off-network applications 148. As a more concrete example, a VRF oracle may be combined with a sports data oracle to determine player lists, results, and/or odds related to a fantasy sports league or tournament. Relatedly, a VRF may be used to determine one or more individuals of a set of two or more individuals who correctly predicted the result of a sports game or horse race, for example, to which a return amount is to be distributed. In such an example, a sports data oracle may provide data/information 146 related to the sports game, and the VRF may provide data/information 146 in the form of a random value based on which the one or more winners may be chosen from the group of individuals who chose correctly.

Using an off-network application 148 to execute the rules defined by the smart contract may allow a user to trust the system/machine more completely because of the immutability and verifiability of the distributed ledger network 144 and the off-network application 148. That is, a user can rest assured that there are no malicious actors who have access to the statistics or information being communicated or transferred by the system and can verify the mathematical/statistical probabilities of the return functions by accessing one or more nodes of the distributed ledger network 144 and the rules defined by the smart contract.

In some examples, the rules defined by the smart contract may conduct further analyses/determinations with the data/information 146 received from the one or more off-network application(s) 148. For example, in the context of a random value being returned from a VRF, the smart contract may map the random value to a function of return possibilities to determine a return multiplier. As discussed in more detail below, the random value received from the VRF may be input into, or plotted on, a function/graph of potential returns or return multipliers. The result of that input/plot may, in combination with the wager placed by the user, be used to determine the return amount to be dispersed to the user and/or deposited to a balance associated with a wallet address associated with the user.

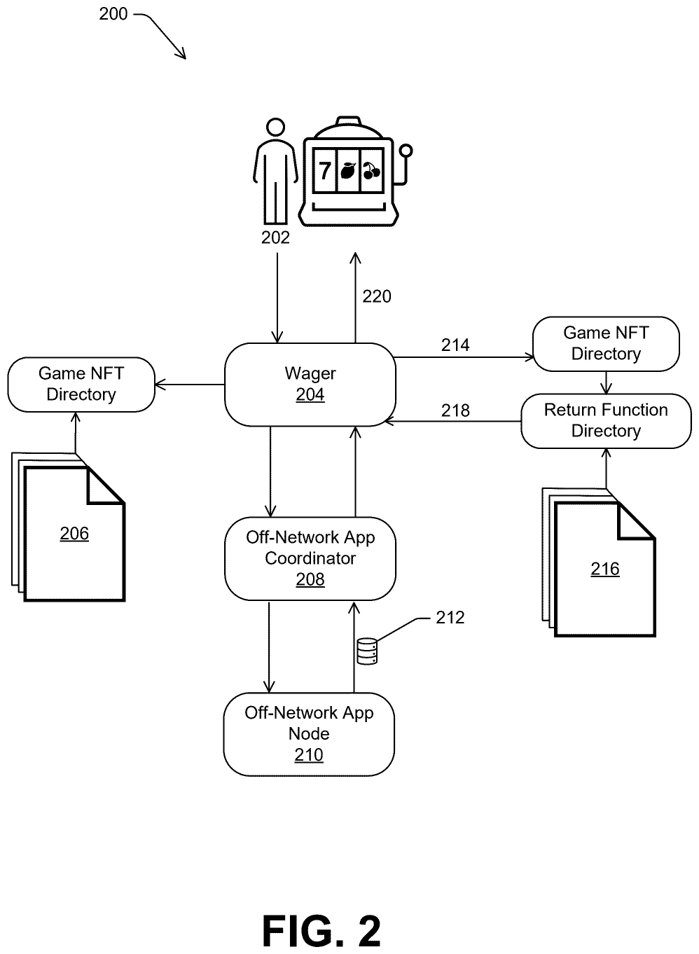

FIG. 2 depicts a flow diagram of an example process 200 for a user 202 placing a wager and receiving a return amount associated with an improved distributed ledger network architecture, according to an embodiment described herein. Such an example process 200 may constitute in part or in whole an exchange of interaction data as depicted by FIG. 1. For example, the user 202 may determine an amount of currency (e.g., cryptocurrency or otherwise) that they wish to wager 204 and may execute a trigger or initiator (e.g., push a “bet” button, pull a slot machine handle, confirm a wager amount, select a player/team, etc.) associated with the game theme or machine. In some examples, the wager 204 may comprise a fee and/or royalty associated with the game, operator, machine, and/or the off-network application 148. As discussed herein, when the user 202 executes the wager 204, a smart contract may be generated on a node of a distributed ledger network 144. The terms of the smart contract may be self-executing to carry out at least part of the example process 200. In such examples, a game NFT directory may retain the royalty or fee prior to executing the game. In some examples, the game NFT directory may store and/or have access to a database 206 of game formats, systems, rules, etc. The NFT directory may receive the wager 204 amount and/or a game ID or other game/format identifier and may determine the game characteristics (e.g., visual/aesthetic characteristics, game rules/odds, royalty amount, payout function to be used, etc.) associated with the game ID. Additionally or alternatively, the wager 204 may comprise a wallet address of a wallet associated with the user 202.

In some examples, the game NFT directory is a collection of metadata associated with the smart contracts that may contain the payout/return function. In addition to pointing to an on-network address/location associated with the smart contract, the metadata stored by the game NFT directory may include information like the game title and graphics, the royalty address for the game (e.g., where a portion of wagers may be allocated), a uniform resource identifier (URI) that may point to associated frontend graphics/interfaces associated with the game. The frontend and/or graphical user interface (GUI) may contain the user interface elements and/or game characteristics and may be hosted in a decentralized manner.

The wager 204 and/or associated data (e.g., game format, game ID, game operator, wallet address) may then be transmitted to an off-network application coordinator 208. The off-network application coordinator 208 may receive and/or interpret the wager and/or associated data to determine which, if any, one or more off-network applications should be called on to determine a return amount. By way of example and not limitation, if the game ID received by the off-network application coordinator 208 is associated with a slot machine or similar random-value based game format, the off-network application coordinator 208 may determine that a random value from a verifiable random function (VRF) oracle should be requested. In another example, the off-network application coordinator 208 may determine, based at least in part on the received data associated with the wager 204, that the game format is related to an over/under on a sports competition, and the off-network application coordinator 208 may determine that a sports data oracle should be lined up/called on to provide information pertinent to determining the return amount. The off-network application coordinator 208 may then send data/information associated with the wager (e.g., a request ID, a wallet address, etc.) to the pertinent off-network application node 210.

The off-network application node 210 may then fulfill the request received from the off-network application coordinator 208 and send the requested data/information 212 to the off-network application coordinator 208. Data/information 212 may comprise data/information 146 as depicted in FIG. 1. In the above examples, the off-network application node 210 may be a VRF oracle and the data/information 212 may be a random value sent to the off-network application coordinator 208. In other examples, the off-network application node 210 may be a sports data oracle and the data/information 212 sent to the off-network application coordinator 208 may be the result of the sports competition (e.g., the winning team/individual, total score, point spread, individual player stat lines, etc.). As discussed above, the off-network application node 210 may, prior to sending the data/information to the off-network application coordinator 208, independently generate a proof or similarly verifiable and immutable record of how the data/information 212 was determined. In some examples, the off-network application node 210 may publish and/or verify the proof on the distributed ledger network 144 to ensure provable fairness and verifiable randomness.

In some examples, upon receipt of the data/information 212, the off-network application coordinator 208 may relay the data/information 212 to the smart contract. The off-network application coordinator 208, may, in some examples, verify the data/information 212 received from the off-network application node 210 to confirm the data/information 212's accuracy and/or to confirm that the data/information 212 has not been tampered with or otherwise altered by a malicious actor or otherwise. In some examples, the data/information 212 relayed from the off-network application coordinator 208 may be comprise, or be associated with, a request identifier indicative of the initial wager. At operation 214, the rules defined by the smart contract may, upon receipt of the data/information 212, determine a return amount based at least in part on the data/information 212. For example, the rules defined by the smart contract may execute a ‘lookup’ process using the data/information 212 and/or a game ID to determine what return/payout function is associated with the wager 204. For example, at operation 214, the rules defined by the smart contract may search for or otherwise locate the game ID in a game NFT directory and/or the database 206 associated with the game NFT directory to determine which payout function (e.g., set or function of return possibilities) to apply to determine the user 202's return amount. In some examples, the game NFT directory may comprise a return function directory 216 which May comprise a retrievable database that stores game formats, systems, rules, functions of return possibilities or multipliers, ‘house edge’ calculations etc. As a nonlimiting example, the rules defined by the smart contract may receive a game ID and a verified random value from the off-network application coordinator 208 and may use the game ID to retrieve or locate the rules and/or possible return multipliers in the game NFT directory (which may itself comprise and/or have access to a return function directory 216). The return functions stored in the return function directory 216 may be different/unique for each game ID, meaning each game or format has its own corresponding return function.

As discussed above, in some examples, the game NFT directory is a collection of metadata associated with the smart contracts that may contain the payout/return function. In addition to pointing to an on-network address/location associated with the smart contract, the metadata stored by the game NFT directory may include information like the game title and graphics, the royalty address for the game (e.g., where a portion of wagers may be allocated), a uniform resource identifier (URI) that may point to associated frontend graphics/interfaces associated with the game. The frontend and/or graphical user interface (GUI) may contain the user interface elements and/or game characteristics and may be hosted in a decentralized manner. Additionally or alternatively, the return functions stored in the return function directory 216 may be used by two or more game IDs or formats. As a nonlimiting example, two different slot machine formats or themes may rely on the same function of return possibilities, while a Texas hold 'em game format may correspond to or be associated with its own distinct function of return possibilities stored in the return function directory 216.

Using the random value and the appropriate return function, the rules defined by the smart contract may then determine a multiplier based at least in part on the return function and the data/information 212. As a nonlimiting example, in the case of a random value being sent by the off-network application coordinator 208 from a VRF, the rules defined by the smart contract may map the random value to a function of return possibilities. As discussed in more detail below, the random value may be used to locate, lookup, or otherwise associate a return multiplier on the function of return possibilities with the random value.

At operation 218, example process 200 may send the return multiplier back to the smart contract, where the rules defined by the smart contract may determine the return amount to be paid to the user 202. For example, based at least in part on the return multiplier and the wager 204 placed by the user 202, a return amount may be determined by applying the return multiplier to the wager 204 amount. For the sake of clarity and not limitation, if the random value is mapped to a return multiplier of 2.5× on the function of return possibilities, and the user 202 placed a wager 204 of 10 ETH tokens, the rules defined by the smart contract may determine that the return amount to be distributed to the user 202 is 10 ETH (2.5), meaning the user 202 should be distributed 25ETH tokens. In some examples, a house fee or royalty may be introduced prior to distributing the return amount to the user 202. For example, if the user 202 has agreed or consented to a house (e.g., casino or operator) royalty or fee of some portion of the user 202's return amount, the rules defined by the smart contract may allocate or divert the appropriate royalty/fee prior to paying out the user 202. In the context of the previous example, if the user 202 has agreed to a 1% royalty to the casino applied to their returns (or, e.g., a 0.001ETH fee on each transaction), the rules defined by the smart contract may apply the royalty to the user 202's return amount of 25ETH tokens, meaning the house is allocated 0.25ETH tokens.

In other examples, as discussed above, the house or operator is allocated a portion of the user 202's wager 204 amount prior to the return amount being determined. Such may be the case, for instance, because of the inherent risk in gambling that the user 202 may be allocated a return multiplier of Ox, meaning the user 202 would lose the entirety of their wager 204. There may be some instances, however, that a user 202 places a wager 204, the entirety of the wager amount is applied to the gambling architecture/determination, and the casino or operator takes a portion (i.e., their cut) contingent on the user 202 receiving a threshold return amount (e.g., more than 0.0, more than 3.0 tokens, more than 30% of the initial wager, etc.). There are myriad ways to structure the house or operator edge, some discussed, and others contemplated herein.

At operation 220, the rules defined by the smart contract may automatically execute a return of the return amount to the user 202, to a wallet address associated with the user 202, and/or to a balance indicated by the machine, application, or device on which the user 202 placed the wager 204. In the context of token-based cryptocurrencies wagered by the user 202, the rules defined by the smart contract (which may be stored on a node of the distributed ledger network), may mint (i.e., create) or burn (i.e., destroy) the requisite number of whole or partial tokens corresponding to the return amount. In the above nonlimiting example, the rules defined by the smart contract may leverage or generate a request with the distributed ledger network 144 to mint 24.75ETH tokens (in the case of a 1% operator fee/royalty) or 25.00ETH tokens (in the case of no operator fee/royalty) to be distributed to the user 202. The return amount may be allocated to a user balance on the machine, application, or device that the user 202 used to place the wager 204 or may be automatically deposited by the smart contract into a wallet associated with the user 202. In some examples, the return amount may additionally or alternatively be converted to a different currency (crypto or otherwise) prior to being distributed to the user 202. For example, the user 202 may have placed a wager 204 using ETH tokens but may want their return amount in Tether tokens (or, e.g., in $USD). In such an example, the rules defined by the smart contract may, either before or after minting/burning the amount of currency indicated by the return amount, convert the return amount from ETH tokens to Tether tokens based at least in part on an exchange rate and/or relative value determined by the smart contract (e.g., by requesting a real-time exchange rate from an off-network application 148, by retrieving real-time relative values from a retrievable database, etc.). In some examples, the smart contract may determine the converted return amount using exchange rate data at the time/moment the user 202 placed the wager 204, thereby reducing the risk of the user 202 and/or operator increasing or decreasing their distribution of the return amount because of a fluctuation in the value of the currency in the period since the user 202 placed their wager 204.

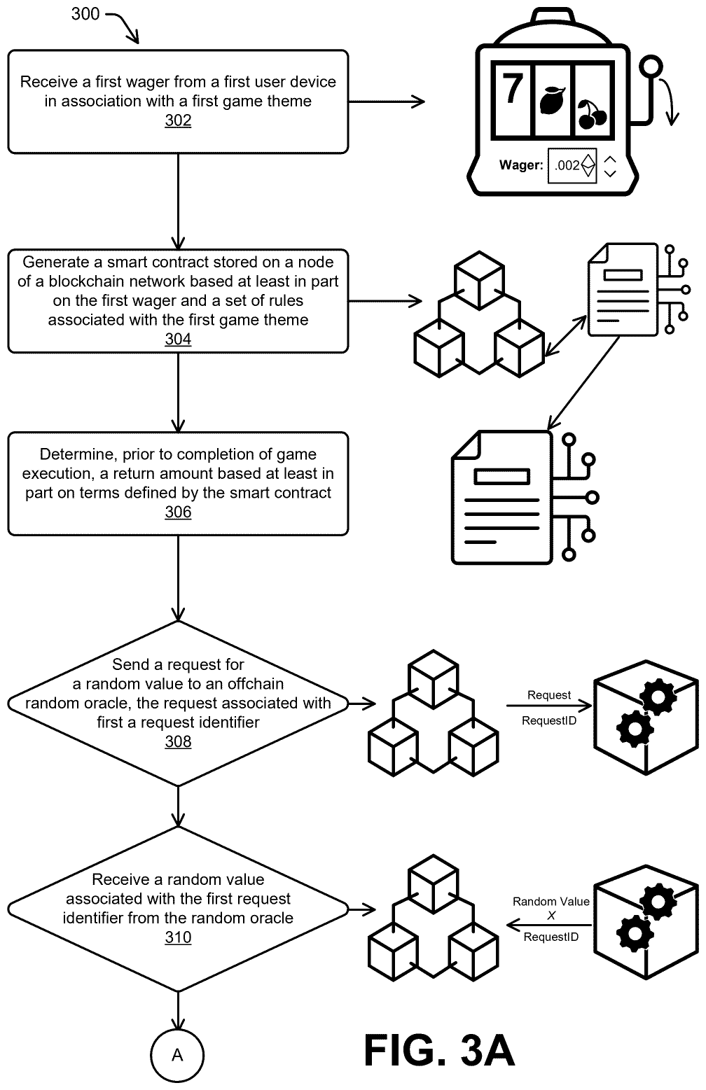

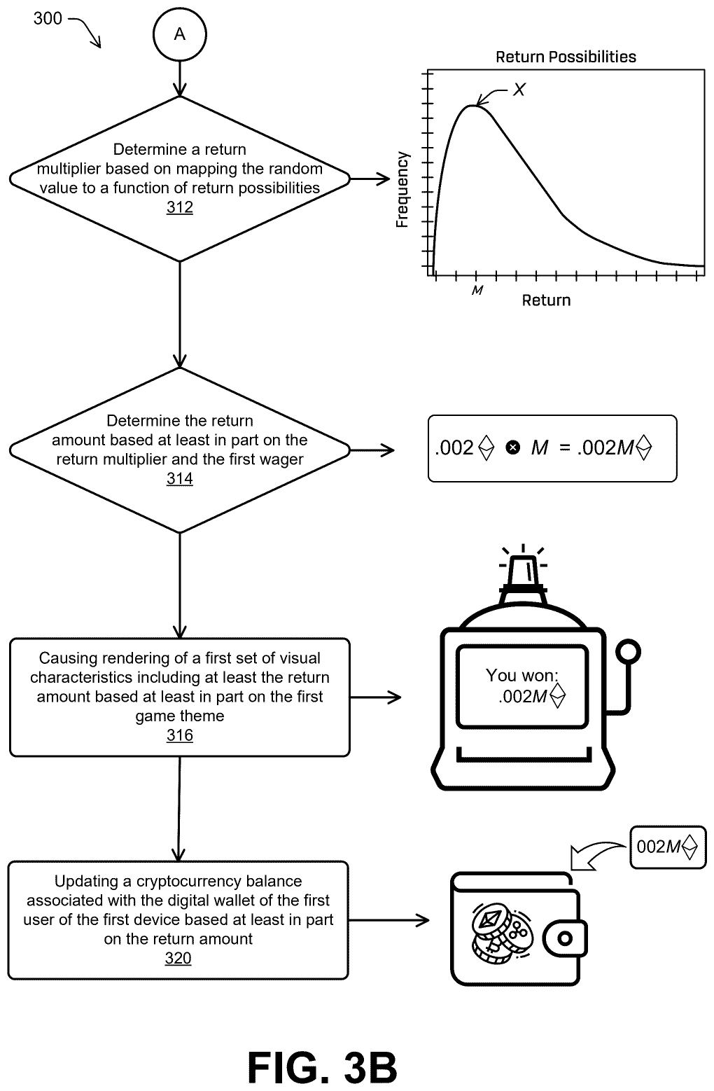

FIGS. 3A and 3B depict a pictorial flow diagram of an example process 300 for a user interacting with an improved distributed ledger network architecture, according to an embodiment described herein. At operation 302, example process 300 may include receiving a first wager from a first user device in association with a first game theme. In some examples, the first wager may correspond to an amount of cryptocurrency (e.g., ETH, Tether, USDC, etc.) associated with a digital wallet of a first user using the first user device. For the sake of clarity and not limitation, the first wager is depicted as 0.002ETH tokens and the first user device is depicted as a slot machine. In some examples, the first user device may be a smartphone or other internet-connected useable/wearable device, a machine or device owned/operated by a casino or operator (e.g., a slot machine, a blackjack table, a kiosk at a racetrack (e.g., horse races, vehicle races), etc.). The first game theme may be any application or set of characteristics that facilitate or enhance a user's interactions. As nonlimiting examples, a smart phone or tablet application may display a blackjack table to a user, a slot machine may display various visual/auditory effects designed to enhance the game experience and distinguish the machine from others, a kiosk may display competitors, odds, records, and/or other pertinent information associated with a game or game theme.

At operation 304, example process 300 may include generating, based at least in part on the first wager and the first game theme, a wager transaction that interacts with a published smart contract stored on a node of a blockchain (or other distributed ledger network), where the set of rules defined by the smart contract indicate how a return amount is to be determined. As discussed above, smart contracts are immutable and verifiable sets of terms/rules/conditions that may be stored on a node of a distributed ledger network and may be capable of self-executing (i.e., without a second or third party) various actions or processes automatically when certain terms/rules/conditions are met. The consensus-required nature of distributed ledger networks ensures that the rules defined by the smart contract are immutable, meaning malicious actors are incapable of changing terms, values, identities, etc., without disrupting the entire chain in the distributed ledger network and thereby throwing off the consensus requirement. Further, the transactions and interactions executed by the rules defined by the smart contract are viewable and verifiable by operators, computing devices, or others with access to the distributed ledger network. Such functionality ensures that a user of the first user device is guaranteed a confirmable, provable mathematical function and determination of the return amount using the techniques described herein. The set of rules associated with the first game theme may include a location of a retrievable database of return possibilities (e.g., a game NFT directory), a royalty or fee amount, a set of instructions for determining the return amount, conditions to be satisfied prior to executing the determination of the return amount and/or prior to distributing the return amount to the user's balance (e.g., verifying the user's identity or wallet address), etc.

In some instances, computing device(s) and/or machine learning model(s) may parse the rules defined by the smart contract to weed out, filter, or otherwise remove conditions, data, and/or information unnecessary to the determination of the return amount. In such an instance, the parsed/updated smart contract with conditions or data removed may be sent to a second node of the distributed ledger network for verification, execution, or otherwise. Doing so may increase the speed at which the return amount is determined (thereby improving the user experience by reducing latency and ensuring smooth/responsive transitions and displays), may decrease the burden on the computationally expensive distributed ledger network (e.g., by reducing memory use), and/or otherwise improve the overall system by filtering out (i.e., parsing) unnecessary data/instructions.

At operation 306, example process 300 may include determining, prior to completion of game execution, a return amount based at least in part on the rules defined by the smart contract. Determining the return amount prior to execution may have myriad benefits including, but not limited to, increasing the scalability of the techniques described herein by allowing the processes/systems to be applied to numerous game devices and/or formats, improving the user experience by increasing responsiveness and helping ensure smooth, reactive content transitions/interactions, etc. As a nonlimiting example, the techniques described herein may be applied to one or more slot machines independent of the operator or theme, one or more craps tables or applications, and one or more sports wagering formats or applications all the same, without sacrificing any of the benefits discussed. Executing the rules defined by the smart contract in the background (from the user's perspective) prior to completion of game execution may also reduce latency and enhance user trust by ensuring mathematically verifiable results with low lag that occur distinct from the operator or casino. In other words, in such examples, a user is guaranteed that the game is provably fair and just, and should have no reason to believe an online or in-person experience is in any way different than sitting down at a blackjack table or craps table at a sanctioned casino.

As depicted in FIGS. 3A and 3B, the rules defined by the smart contract appear as trapezoidal nodes/boxes. At operation 308 of example process 300, the rules defined by the smart contract as discussed above may include sending a request for a random value to an offchain (i.e., off-network) random oracle, wherein the request may be associated with a first request identifier. As discussed above, the first request identifier may be a unique identification number or hash value associated with the first wager placed by the user such that the smart contract can determine the return amount and distribute the return amount to the corresponding user and/or device associated with the first request identifier. As discussed herein, the off-chain random oracle may additionally or alternatively be an off-network application configured to receive requests for data/information and fulfill those requests with the appropriate data/information 212. For instance, the off-network application may be a verified random function (VRF) oracle, a data oracle (e.g., weather, sports, price/exchange rate, etc.), an internet of things (IoT) oracle configured to communicate with smart devices and/or other connected hardware, a legacy system or service, and so on.

At operation 310, the rules defined by the smart contract may receive, from the offchain random oracle, a random value associated with the first request identifier. As depicted for the sake of clarity, X represents the random value received from the offchain random oracle. For example, the offchain oracle may comprise a VRF configured to return verifiable mathematically random values in response to requests for such values. In the depicted example, the offchain random oracle may determine a random value, associate it with the first request identifier, and send the random value back to the node storing the smart contract, thereby fulfilling the request sent by the smart contract. In other examples, rather than a random value, the off-network application may determine the result of a sporting event, may retrieve or otherwise determine pertinent weather data, may retrieve current or past stock market data, and so on.

Turning now to FIG. 3B, at operation 312 of example process 300, the rules defined by the smart contract may include determining a return multiplier based at least in part on mapping the random value received from the random oracle to a function of return possibilities. As depicted by FIG. 3B, the function of return possibilities may be a representation of potential payout return multipliers graphed against the frequency of occurrence of such return multipliers. As a nonlimiting example and as depicted, return possibilities with relatively fewer occurrence frequencies may comprise higher return multipliers (i.e., a bigger multiplier is less likely to happen). Said differently, a user may be relatively more likely to win a small amount or zero than they are to win a large amount, meaning the frequencies of lower return multipliers may be greater. In some examples, the function of return possibilities may be normalized such that the majority of returns (e.g., the 25th to 75th percentiles) occur somewhere around a 1.0×, meaning across many instances/wagers, on average a return multiplier of somewhere around 1.0× (or slightly less than 1.0 to reflect a house edge) may be determined. There are myriad return possibility functions that may be used depending on the game format, theme, rules, etc. In some examples, a house edge may be introduced by shifting the function of return possibilities such that larger multipliers are less frequent and smaller multipliers (e.g., 1.0× or within a threshold range of 1.0×) are more frequent.

As depicted, X represents the random value received from the random oracle, and as shown by FIG. 3B, the rules defined by the smart contract may map X to the corresponding datapoint/value along the function of return possibilities, depicted in FIG. 3B as falling at return multiplier M. For the sake of clarity, X is depicted as corresponding to one of the most frequently occurring return multipliers. As discussed in more detail above, the game NFT directory may retain or store metadata about smart contracts associated with any given game, including but not limited to the on-network contract address/location that may house the payout/return logic, the game title, the royalty address where a portion of wagers are allocated, and/or a uniform resource identifier (URI) associated with the decentralized frontend/GUI hosting user interface elements and game characteristics.

At operation 314 of example process 300, the rules defined by the smart contract may include determining the return amount based at least in part on the return multiplier and the first wager. For example, the return multiplier M in the previous example may be applied to the first wager placed by the first user to determine the return amount. In the depicted example, the first wager is 0.002ETH tokens, and the return multiplier is M. Thus, for the sake of clarity, the first user's first wager of 0.002ETH is multiplied by a return multiplier of M, meaning the return amount to be distributed back to the first user is 0.002M. As a more concrete nonlimiting example, M may be 1.2×, meaning the return amount may be 0.002 (1.2)=0.0024.

At operation 316, example process 300 may include causing, based at least in part on the first game theme, rendering of a first set of visual characteristics including at least the return amount on the first user device, wherein causing rendering of the first set of visual characteristics occurs offchain such that memory use by the blockchain network is reduced. For example, the user device may render visual characteristics like flashing lights and congratulatory animations along with the return amount to enhance the user experience and to display to the user how much (or little) they won (or lost). As a nonlimiting example, a slot machine may flash lights, draw connections between wheels/shapes, and/or display an animation to the user that shows the user the return amount they won. Causing rendering of the visual and/or auditory characteristics to display the return amount to the user may occur locally on the user device and/or otherwise separate from the distributed ledger network 144 (i.e., blockchain). Doing so may reduce the memory use and computational expense required of the distributed ledger network 144 by limiting the tasks accomplished on the distributed ledger network 144 to just those defined by the smart contract. Causing rendering of the visual and auditory characteristics may, in some examples, occur at the device level, which may have access to a game NFT directory (either local to the device or remote), a retrievable database, and/or a remote server that may store various game rules, animations, visual characteristics, etc. The user device may communicate via one or more network(s) 150 to access the retrievable database to determine what visual characteristics correspond to the game theme on which the first user placed their wager and may use that information to display to the first user the return amount along with other visual or audio characteristics designed to enhance the user experience. Causing rendering of the game characteristics separate from the distributed ledger network 144 may also improve the scalability of the techniques described herein by allowing an operator to apply the processes/methods discussed to numerous different gambling formats and games without sacrificing the verifiability, fairness, or enhanced experience to the user.

At operation 320, example process 300 may include updating, based at least in part on the return amount, a cryptocurrency balance associated with the digital wallet of the first user of the first user device. For example, the digital wallet of the first user may be increased and/or decreased depending on the return amount, which may in some examples comprise minting (i.e., creating) and/or burning (i.e., destroying) coins. In the depicted example discussed above, the return amount of 0.002M ETH is deposited back into the first user's digital wallet to reflect the first user's return amount (i.e., winnings). In other instances, a user's return amount may be converted into a different currency prior to updating the digital wallet that is associated with the user. As discussed in more detail above, the currency of which the user placed the first wager may comprise a first cryptocurrency, and the user may specify that they want their return amount converted into a different cryptocurrency or currency. In some examples, rather than updating the balance associated with a digital wallet of the first user, the return amount may be used at least in part to update a current account balance of the first user on the first user device. In such examples, the first user may have a balance displayed to them on the first user device they are using, and the return amount may be added to the balance. The first user may then initiate or complete a transfer of the balance or a portion thereof to their bank account and/or digital wallet address. In such examples, the balance of the first user may be local to the first user device that they are using, and they may ‘cash-out’ their balance at the end of their session or experience.

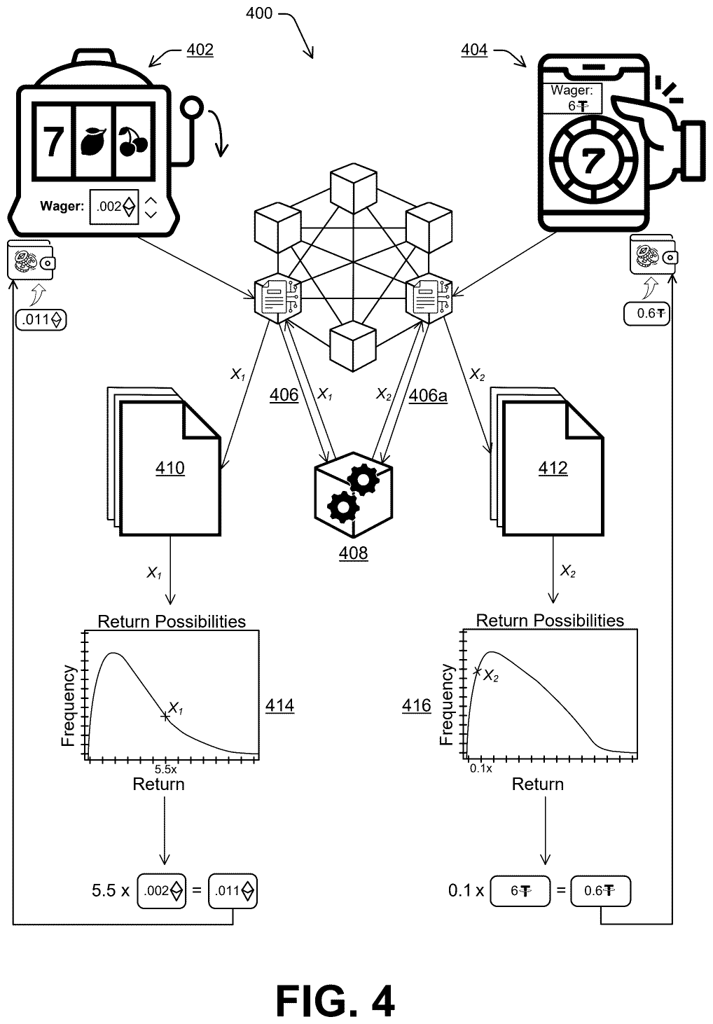

FIG. 4 depicts a block diagram of an example system 400 for implementing various techniques described herein. For example, as depicted, a first user may place a first wager on a first user device 402 and a second user may place a second wager on a second user device 404. In some examples, the first user device 402 and second user device 404 may be different instances of the same device (e.g., two smart phone applications, two slot machines, etc.), and/or may be configured to generate the same game rules/format for display to the first user and second user. In other examples, and as shown in FIG. 4, the first user device 402 may be different than the second user device 404 and may be configured to generate the same rules/format, or the first user device 402 may be the same device as the second user device 404 and may be configured to generate different games/formats to the first user and second user (e.g., the first user device 402 and the second user device 404 are both tablets, but the first user device 402 displays online blackjack and the second user device 404 displays online craps). For the sake of clarity, as depicted the first wager placed with the first user device 402 is 0.002ETH tokens with a slot machine and the second wager placed with the second user device 404 is 6.0 Tether tokens with a smartphone. When the first user and second user place their respective first and second wagers, a first smart contract may be generated for the first wager and a second smart contract may be generated for the second wager. As shown, the first wager placed by the first user may generate a first smart contract on a first node of the distributed ledger network 144, and the second wager placed by the second user may generate a second smart contract on a second node of the distributed ledger network. In some examples, the first wager and the second wager may generate or rely on a single smart contract rather than generating unique smart contracts. In other examples, the first smart contract and second smart contract may be generated on different distributed ledger networks which may be communicatively coupled with one another (e.g., by using an off-chain network application).

As discussed in more detail above, the rules defined by the first smart contract and/or the rules defined by the second smart contract may send a request for a random value (or other data/information 212) to an off-network application 408. For example, as depicted, the first smart contract may send a first request 406 for a random value to an off-network application 408, and the second smart contract may send a second request 406a for a random value to the off-network application 408. The off-network application 408 may, simultaneously or sequentially (e.g., in the order the requests were received), fulfill such requests by verifiably determining a random value and sending the random value back to the requesting smart contract (based on, e.g., the request identifier associated with the request). For example, as depicted, the first smart contract may receive a first random value X₁ from off-network application 408 and the second smart contract may receive a second random value X₂ from the off-network random application 408.

The rules defined by the first smart contract and the second smart contract may determine, based at least in part on the respective first random value X₁ and second random value X₂, a first multiplier and a second multiplier. The first smart contract may locate, lookup, search, or otherwise determine the rules of the first game associated with the first user's first wager which may comprise an appropriate first function of return possibilities 414 associated with the first game. The first function of return possibilities 414 may be determined using a first game NFT directory 410, a first server or remote computing device, a first database, and so on. Relatedly, the second smart contract may locate, lookup, search, or otherwise determine the rules of the second game associated with the second user's second wager which may comprise the appropriate second function of return possibilities 416 associated with the second game. The second function of return possibilities 416 may be determined using a second game NFT directory 412, a second server or remote computing device, a second database, and so on. In some examples, the first function of return possibilities 414 and the second function of return possibilities 416 may be determined using the same NFT directory, server, remote computing device, and/or database. The rules defined by the first smart contract and the rules defined by the second smart contract may use the respective first random value X₁ and second random value X₂ to determine the respective first return multiplier and second return multiplier. In some examples, the rules defined by the first smart contract may additionally associate a first request ID or similar first identifier with the first smart contract and/or first wager, and/or the rules defined by the second smart contract may additionally associate a second request ID or similar second identifier with the second smart contract and/or second wager such that the return amounts of each can be tracked back to or associated with the corresponding wager, user device, wallet address, etc. For example, first request ID may be configured to associate the first return amount with the first user device 402 and second request ID may be configured to associate the second return amount with the second user device 404.

In some instances, the first game and the second game may use the same function of return possibilities to determine the first multiplier and second multiplier. In other instances, each game, format, and/or theme may use different functions of return possibilities to reflect different return multiplier frequencies, different return amounts/multipliers, different house edges or royalties/fees, different wager amounts, and so on. As depicted, the first function of return possibilities 414 comprises a first set of return multipliers with frequencies different than the second set of return multipliers depicted by the second function of return possibilities 416. For the sake of clarity and as shown, the rules defined by the first smart contract map the first random value X₁ to a first multiplier of 5.5× on the first function of return possibilities 414 and the rules defined by the second smart contract map the second random value X₂ to a second multiplier of 0.1× on the second function of return possibilities 416.

In some examples, the rules defined by the first smart contract may determine a first return amount based at least in part on the first multiplier and the first wager, and the rules defined by the second smart contract may determine a second return amount based at least in part on the second multiplier and the second wager. As depicted by FIG. 4 and for the sake of clarity and not limitation, the first multiplier is applied to the first wager of 0.002ETH tokens, meaning the first return amount amounts to 0.002ETH (5.5)=0.011ETH tokens. Further, as depicted, the second return multiplier is applied to the second wager of 6 Tether tokens, making the second return amount 6 USDT (0.1)=0.6 Tether tokens. As discussed above, the first wager and second wager may, prior to or after determining the first and second return amount, be subject to an operator royalty, fee, commission, or similar expense that reduces the first return amount or second return amount. Such a royalty, fee, commission, or similar expense may be charged involuntarily or with the first/second user's consent and may be allocated to the operator/casino, application, distributed ledger network (e.g., to pay the VRF fee or other oracle fee). As depicted, the first wager and second wager are not subject to such a royalty, fee, commission, or similar expense and instead the first multiplier and second multiplier are applied to the entirety of the respective first wager and second wager to determine the respective first return amount and second return amount.

In some examples, the first user device 402 may render a first set of game characteristics associated with the first game to display at least the first return amount to the first user. Relatedly, the second user device may render a second set of game characteristics associated with the second game (e.g., the same or a different game than the first game) to display at least the second return amount to the second user. For example, the first user device 402 may display/render, in addition to the first return amount (in the depicted example, 0.011ETH tokens), flashing lights, congratulatory/happy animations, crowd cheering noises, coin or cash register sounds, and so on, to reflect the first user's successful wager. As another example and as also depicted, the second user device 404 may display/render, in addition to the second return amount (in the depicted example, 0.6 Tether tokens), dim or neutral lights, encouraging or supportive special effects, various neutral or non-celebratory sounds, or other characteristics configured to motivate the second user to place another wager or otherwise allow the second user to move on without significant fanfare to reflect the second user's unsuccessful wager.

The first set of game characteristics (e.g., visual, auditory, olfactory, tactile), may correspond to the first game and be determined using a first game NFT directory 410 as discussed above and may be rendered on the first user device 402 separate from the distributed ledger network to reduce memory use on the distributed ledger network. Similarly, the second set of game characteristics (e.g., visual, auditory, olfactory, tactile) may correspond to the second game and be determined using the first game NFT directory 410 or a second game NFT directory 412 as discussed above, and may also be rendered on the second user device 404 separate from the distributed ledger network.

In some examples, a first balance associated with the first user of the first user device 402 may be updated to reflect the first return amount and a second balance associated with the second user of the second user device 404 may be updated to reflect the second return amount. As depicted, the first return amount of 0.11ETH tokens is added to the first balance (e.g., a first digital wallet address) associated with the first user, and the second return amount of 0.6 Tether tokens is added to a second balance (e.g., a second digital wallet address) associated with the second user. In some examples, the first balance may be associated with a first digital wallet associated with the first user and/or the second balance may be associated with a second digital wallet associated with the second user. In other examples and as discussed above, the first balance may be local to the first user device 402 and the second balance may be local to the second user device 404 and the first user and/or second user may cash-out or otherwise batch transfer a cumulation of one or more return amounts that were dispersed/added to the first user balance or second user balance throughout the duration of the first user's or second user's overall interaction duration with the first user device 402 or second user device 404.

FIG. 5 depicts a flow diagram of an example process 500 for artificial intelligence utilization in association with a an improved blockchain architecture, according to an embodiment described herein. The order in which the operations or steps are described is not intended to be construed as a limitation, and any number of the described operations may be combined in any order and/or in parallel to implement example process 500. The example process 500 may be performed utilizing any and/or all of the components described with respect to FIGS. 1-4.

At operation 502, example process 500 may include generating one or more artificial intelligence models configured to generate as output at least a portion of data comprising a smart contract as discussed above. For example, the artificial intelligence models may utilize analytic techniques, which may include, for example, modeling, artificial intelligence, and/or data mining. Generally, predictive modeling may utilize statistics to predict outcomes. Artificial intelligence, while also utilizing statistical techniques, may provide the ability to improve outcome performance without being explicitly programmed to do so. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, graph neural networks and/or rules-based artificial intelligence.

Information from stored and/or accessible data may be extracted from one or more databases, such as any datastore that stores any or all of the data described above, and may be utilized to predict trends, behavior patterns, and/or determine efficient processes/code by parsing and/or filtering unnecessary data, information, or instructions. The analytic techniques may be utilized to determine associations and/or relationships between explanatory variables and predicted variables from past occurrences and utilize these variables to predict the unknown outcome. The analytic techniques may include defining the outcome and data sets used to predict the outcome.

Data analysis may include using one or more models, including for example one or more algorithms, to inspect the data with the goal of identifying useful information (and/or non-useful or non-critical information) and arriving at one or more determinations like the efficiency/efficacy of the one or more algorithms or the performance of the memory use of the one or more algorithms. One or more validation operations may be performed, such as using statistical analysis techniques, to validate accuracy of the models. Thereafter modeling may be performed to generate accurate models.

At operation 504, example process 500 may include collecting feedback data over a period of time. The feedback data may include any of the data described above with respect to FIGS. 1-4, or any other data that may be utilized to perform the operations described herein. This information may include, for example, historical data as described above, feedback data as described herein, testing datasets as described herein, etc.

At operation 506, example process 500 may include generating a training dataset from the feedback data. Generation of the training dataset may include formatting the feedback data into input vectors for the artificial intelligence model to intake, as well as associating the various data with the outcomes of the operations described herein.

At operation 508, example process 500 may include generating one or more trained artificial intelligence models utilizing the training dataset. Generation of the trained artificial intelligence models may include updating parameters and/or weightings and/or thresholds utilized by the models to determine content and/or recommendations to be displayed, to determine thresholds, to determine conditions, to determine garbage data or similarly unnecessary information/instructions, to determine an order to execute various rules, conditions, or terms, to determine contextual information subsets, to determine memory-use inefficiencies (e.g., with respect to the smart contract or to the use of a distributed ledger network), to perform any other operations described with respect to AI models above, and the like.

At operation 510, example process 500 may include determining whether the trained artificial intelligence models indicate improved performance metrics. For example, a testing group may be generated where the outcomes of determinations are known but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, example process 500 may include, at operation 512, utilizing the trained artificial intelligence models for generating subsequent results (e.g., an updated smart contract or an updated set of rules defined by the smart contract). For example, the trained artificial intelligence models may be utilized to determine content and/recommendations to be displayed, to determine thresholds, to determine conditions, to determine garbage data or similarly unnecessary information/instructions, to determine an order to execute various rules, conditions, or terms, to determine contextual information subsets, to determine memory-use inefficiencies (e.g., with respect to the smart contract or to the use of a distributed ledger network), to perform any other operations described with respect to AI models above, and the like. It should be understood that the trained artificial intelligence models may be utilized in any scenario where models are utilized as described herein.

In examples where the trained artificial intelligence models do not indicate improved performance metrics, example process 500 may include, at operation 514, utilizing the previous iteration of the artificial intelligence models for generating subsequent results.

### Example Process

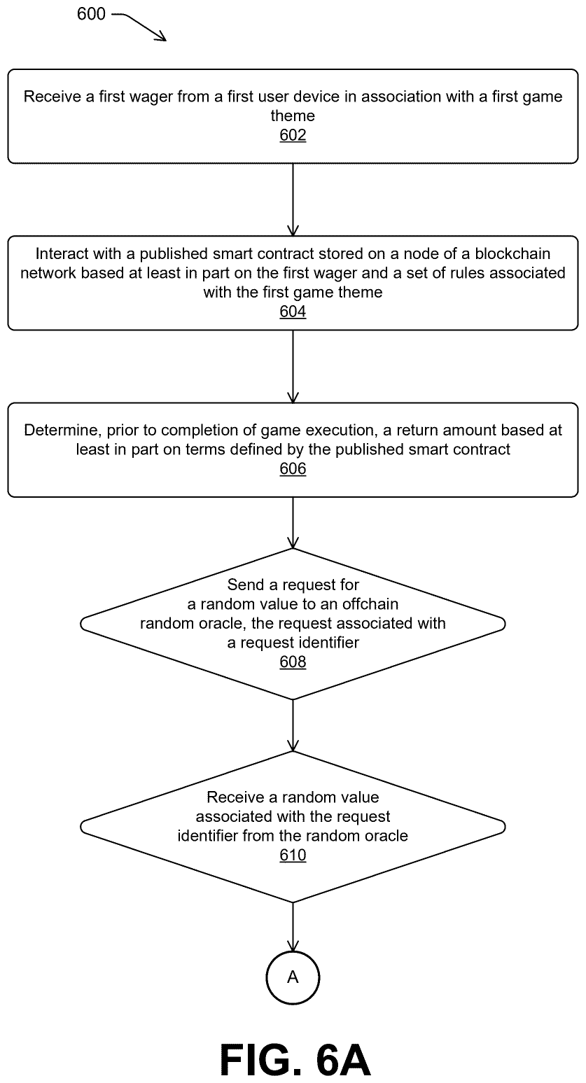

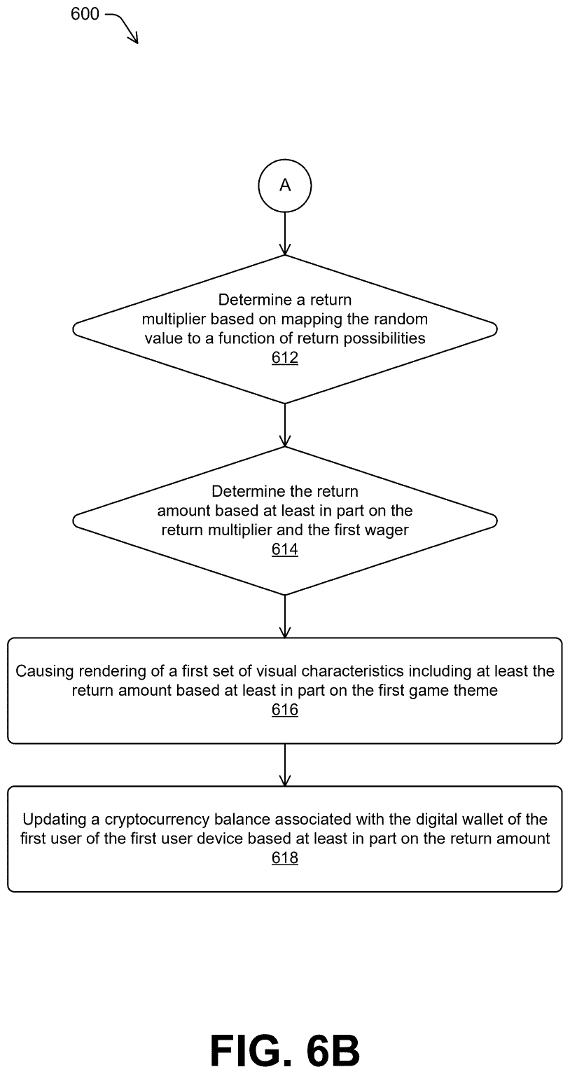

FIGS. 6A and 6B illustrate a flow diagram of an example process 600 for a user interacting with an improved distributed ledger network architecture, according to an embodiment described herein. Turning to FIG. 6A, at operation 602, example process 600 may include receiving a first wager from a first user device in association with a first game theme. In some examples, the first wager may correspond to an amount of cryptocurrency associated with a digital wallet of a first user of the first user device.

At operation 604, example process 600 may include interacting with a published smart contract stored on a node of a blockchain network based at least in part on the first wager and a set of rules associated with the first game theme. In some examples, the set of rules may indicate how return amounts are to be determined.

At operation 606, example process 600 may include determining, prior to completion of game execution, a return amount based at least in part on terms defined by the published smart contract.

At operation 608 of example process 600, the terms defined by the published smart contract may comprise sending a request for a random value to an offchain random oracle, the request associated with a request identifier. At operation 610 of example process 600, the terms defined by the published smart contract may additionally or alternatively comprise receiving, from the offchain random oracle, a random value associated with the first request identifier.

Turning to FIG. 6B, at operation 612 of example process 600, the terms defined by the published smart contract may additionally or alternatively comprise determining a return multiplier based at least in part on mapping the random value to a function of return possibilities. At operation 614 of example process 600, the terms defined by the published smart contract may additionally or alternatively comprise determining, based at least in part on the return multiplier and the first wager, the return amount.

At operation 616, example process 600 may include causing rendering of a first set of visual characteristics on the first user device that may include at least the return amount based at least in part on the first game theme.

At operation 618, example process 600 may include updating, based at least in part on the return amount, a cryptocurrency balance associated with the digital wallet of the first user of the first user device.

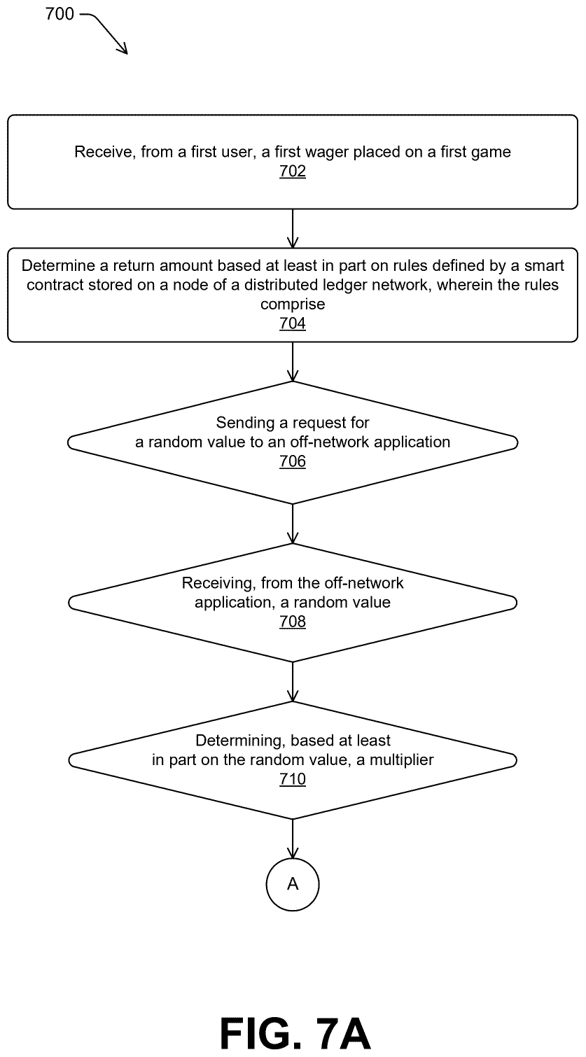

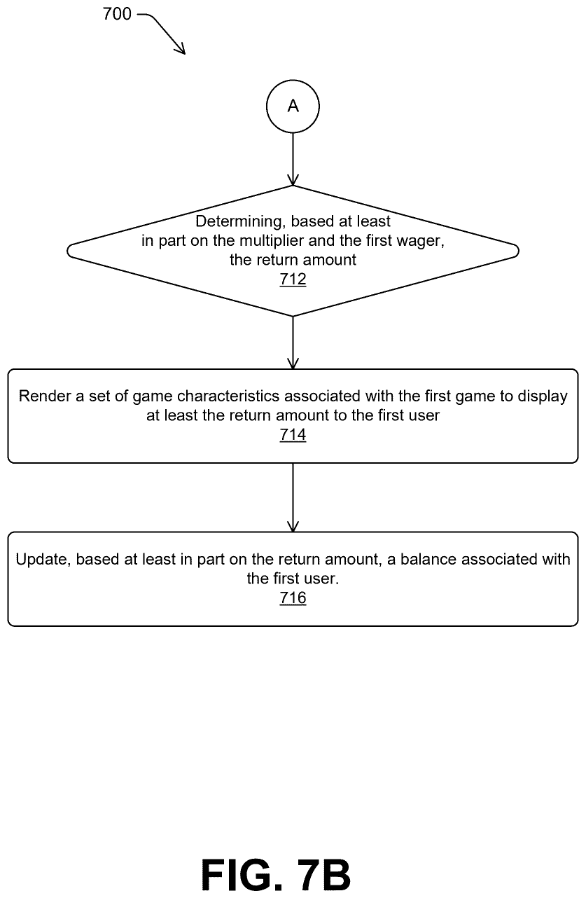

FIGS. 7A and 7B illustrate a flow diagram of an example process 700 for a user interacting with an improved distributed ledger network architecture, according to an embodiment described herein. Turning to FIG. 7A, at operation 702, example process 700 may include receiving, from a first user, a first wager placed on a first game.

At operation 704, example process 700 may include determining a return amount based at least in part on rules defined by a smart contract stored on a node of a distributed ledger network. At operation 706 of example process 700, the rules defined by the smart contract may comprise sending a request for a random value to an off-network application. At operation 708 of example process 700, the rules may additionally or alternatively comprise receiving, from the off-network application, a random value. At operation 710 of example process 700, the rules may additionally or alternatively comprise determining, based at least in part on the random value, a multiplier.

Turning to FIG. 7B, at operation 712 of example process 700, the rules defined by the smart contract may additionally or alternatively comprise determining, based at least in part on the multiplier and the first wager, the return amount.

At operation 714, example process 700 may include rendering a set of game characteristics associated with the first game to display at least the return amount to the first user.

At operation 716, example process 700 may include updating, based at least in part on the return amount, a balance associated with the first user.

### Example Clauses

A. A system comprising: one or more processors; and a non-transitory memory storing processor-executable instructions that, when executed by the one or more processors, cause the one or more processors to perform operations comprising: receiving, from a first user device, a first wager placed in association with a first game theme, the first wager corresponding to an amount of cryptocurrency associated with a digital wallet of a first user of the first user device; interacting with, based at least in part on the first wager and a set of rules associated with the first game theme, a published smart contract stored on a node of a blockchain network, the set of rules indicating how return amounts are to be determined; determining, prior to completion of game execution of the first game theme, a return amount based at least in part on terms defined by the published smart contract, wherein the terms comprise: sending a request for a random value to an offchain random oracle, the request for the random value associated with a first request identifier; receiving, from the offchain random oracle, a random value associated with the first request identifier; determining, based at least in part on mapping the random value to a function of return possibilities, a return multiplier; and determining, based at least in part on the return multiplier and the first wager, the return amount; causing, based at least in part on the first game theme, rendering of a first set of visual characteristics including at least the return amount on the first user device, wherein causing rendering of the first set of visual characteristics occurs offchain such that memory use by the blockchain network is reduced; and updating, based at least in part on the return amount, a cryptocurrency balance associated with the digital wallet of the first user of the first user device.
B. The system of paragraph A, the operations further comprising: receiving, from a second user device, a second wager placed in associated with a second game theme different than the first game theme, the second wager corresponding to an amount of cryptocurrency associated with a second digital wallet of a second user of the second user device; interacting with, based at least in part on the second wager and a second set of rules associated with the second game theme, a second published smart contract stored on a second node of the blockchain network, the second set of rules indicating how return amounts are to be determined; determining, prior to completion of game execution of the second game theme, a second return amount based at least part on second terms defined by the second published smart contract wherein the second terms comprise: sending a second request for a second random value to the offchain random oracle, the second request for the second random value associated with a second request identifier different than the first request identifier; receiving, from the offchain random oracle, a second random value associated with the second request identifier; determining, based at least in part on mapping the second random value to a second function of return possibilities, a second return multiplier; and determining, based at least in part on the second return multiplier and the second wager, the second return amount; causing, based at least in part on the second return amount and the second game theme, rendering of a second set of visual characteristics different than the first set of visual characteristics including at least the second return amount on the second user device, wherein causing rendering of the second set of visual characteristics occurs offchain such that memory use by the blockchain network is reduced; and updating, based at least in part on the second return amount, a second cryptocurrency balance associated with the second digital wallet of the second user of the second user device.
C. The system of paragraph A or B, the operations further comprising associating a wallet address associated with the first user device with the first game theme.
D. The system of any of claims A-C, wherein the terms defined by the published smart contract are based at least in part on parsing the set of rules associated with the first game theme to remove data unnecessary for determination of the return amount, the operations further comprising sending the terms defined by the published smart contract to a second node of the blockchain network for execution.
E. A method comprising: receiving, from a first user, a first wager placed on a first game; determining a return amount based at least part on rules defined by a smart contract stored on a node of a distributed ledger network, wherein the rules comprise: sending a request for a random value to an off-network application; receiving, from the off-network application, a random value; determining, based at least in part on the random value, a multiplier; and determining, based at least in part on the multiplier and the first wager, the return amount; rendering a set of game characteristics associated with the first game to display at least the return amount to the first user; and updating, based at least in part on the return amount, a balance associated with the first user.
F. The method of paragraph E wherein the rules are first rules and the smart contract is a first smart contract, further comprising: receiving, from a second user, a second wager placed on a second game different than the first game; determining a second return amount based at least part on second rules defined by a second smart contract on a second node of the distributed ledger network, wherein the second rules comprise; sending a second request for a second random value to the off-network application; receiving, from the off-network application, a second random value; determining, based at least in part on the second random value, a second multiplier; and determining, based at least in part on the second multiplier and the second wager, the second return amount; rendering a set of game characteristics associated with the second game to display at least the second return amount to the second user; and updating, based at least in part on the second return amount, a second balance associated with the second user.
G. The method of paragraph E or F, further comprising associating a wallet address associated with the first user with an operator of the first game.
H. The method of paragraph G, further comprising determining, based at least in part on sending a query associated with the wallet address to the distributed ledger network, that the balance associated with the wallet address meets or exceeds the first wager.
I. The method of any of claims E-H, wherein the rules defined by the smart contract are based at least in part on parsing a set of rules associated with the first game to remove data unnecessary for determining of the return amount, further comprising: sending the rules defined by the smart contract to a second node of the distributed ledger network for execution.
J. The method of any of claims E-I, further comprising: generating a machine learning model configured to generate as output at least a portion of data comprising the smart contract; receiving feedback data indicating performance of the smart contract; generating a training dataset from the feedback data; training the machine learning model utilizing the training dataset such that a trained machine learning model is generated; and determining, utilizing the trained machine learning model, an updated smart contract to be stored in association with the distributed ledger network.
K. The method of any of claims E-J, wherein rendering the set of game characteristics associated with the first game occurs separate from the distributed ledger network such that memory use by the distributed ledger network is reduced.
L. The method of any of claims E-K wherein the first wager is associated with a first currency, further comprising converting the first currency into a second currency different than the first currency.
M. A system comprising: one or more processors; and a non-transitory memory storing processor-executable instructions that, when executed by the one or more processors, cause the one or more processors to perform operations comprising: receiving, from a first user device, a first wager placed on a first game; determining a return amount based at least part on rules defined by a smart contract stored on a node of a distributed ledger network, wherein the rules comprise: sending a request for a random value to an off-network application; receiving, from the off-network application, a random value; determining, based at least in part on the random value, a multiplier; and determining, based at least in part on the multiplier and the first wager, the return amount; causing a set of game characteristics associated with the first game to render to display at least the return amount on the first user device; and updating, based at least in part on the return amount, a balance associated with a user of the first user device.
N. The system of paragraph M, wherein the rules are first rules and the smart contract is a first smart contract, the operations further comprising: receiving, from a second user, a second wager placed on a second game different than the first game; determining a second return amount based at least part on second rules defined by a second smart contract on a second node of the distributed ledger network, wherein the second rules comprise; sending a second request for a second random value to the off-network application; receiving, from the off-network application, a second random value; determining, based at least in part on the second random value, a second multiplier; and determining, based at least in part on the second multiplier and the second wager, the second return amount; rendering a set of game characteristics associated with the second game to display at least the second return amount to the second user; and updating, based at least in part on the second return amount, a second balance associated with the second user.
O. The system of paragraph M or N, the operations further comprising associating a wallet address associated with a user of the first user device with an operator of the first game.
P. The system of paragraph O, the operations further comprising determining, based at least in part on sending a query associated with the wallet address to the distributed ledger network, that the balance associated with the wallet address meets or exceeds the first wager.
Q. The system of any of claims M-P, wherein the rules defined by the smart contract are based at least in part on parsing a set of rules associated with the first game to remove data unnecessary for determining the return amount, the operations further comprising: sending the rules defined by the smart contract to a second node of the distributed ledger network for execution.
R. The system of any of claims M-Q, the operations further comprising: generating a machine learning model configured to generate as output at least a portion of data comprising the smart contract; receiving feedback data indicating performance of the smart contract; generating a training dataset from the feedback data; training the machine learning model utilizing the training dataset such that a trained machine learning model is generated; and determining, utilizing the trained machine learning model, an updated smart contract to be stored in association with the distributed ledger network.
S. The system of any of claims M-R, wherein causing the set of game characteristics associated with the first game to render occurs separate from the distributed ledger network such that memory use of the distributed ledger network is reduced.
T. The system of any of claims M-S wherein the first wager is associated with a first currency, the operations further comprising converting the first currency into a second currency different than the first currency.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or processor-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent processor-executable instructions stored on one or more non-transitory computer-readable storage media that, when executed by one or more processors, cause a computer or autonomous vehicle to perform the recited operations. Generally, processor-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural. When referring to a collection of items as a “set,” it should be understood that the definition may include, but is not limited to, the common understanding of the term in mathematics to include any number of items including a null set (0), 1, 2, 3, . . . up to and including an infinite set.

Any routine descriptions, elements or blocks in the flow diagrams described herein and/or depicted in the attached figures should be understood as potentially representing modules, segments, or portions of code that include one or more processor-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
a non-transitory memory storing processor-executable instructions that, when executed by the one or more processors, cause the one or more processors to perform operations comprising:
receiving, from a first user device, a first wager placed in association with a first game theme, the first wager corresponding to an amount of cryptocurrency associated with a digital wallet of a first user of the first user device;
interacting with, based at least in part on the first wager and a set of rules associated with the first game theme, a published smart contract stored on a node of a blockchain network, the set of rules indicating how return amounts are to be determined;
determining, prior to completion of game execution of the first game theme, a return amount based at least in part on terms defined by the published smart contract, wherein the terms comprise:
sending a request for a random value to an offchain random oracle, the request for the random value associated with a first request identifier;
receiving, from the offchain random oracle, a random value associated with the first request identifier;
determining, based at least in part on mapping the random value to a function of return possibilities, a return multiplier; and
determining, based at least in part on the return multiplier and the first wager, the return amount;
causing, based at least in part on the first game theme, rendering of a first set of visual characteristics including at least the return amount on the first user device, wherein causing rendering of the first set of visual characteristics occurs offchain such that memory use by the blockchain network is reduced; and
updating, based at least in part on the return amount, a cryptocurrency balance associated with the digital wallet of the first user of the first user device.

2. The system of claim 1, the operations further comprising:
receiving, from a second user device, a second wager placed in associated with a second game theme different than the first game theme, the second wager corresponding to an amount of cryptocurrency associated with a second digital wallet of a second user of the second user device;
interacting with, based at least in part on the second wager and a second set of rules associated with the second game theme, a second published smart contract stored on a second node of the blockchain network, the second set of rules indicating how return amounts are to be determined;
determining, prior to completion of game execution of the second game theme, a second return amount based at least part on second terms defined by the second published smart contract wherein the second terms comprise:
sending a second request for a second random value to the offchain random oracle, the second request for the second random value associated with a second request identifier different than the first request identifier;
receiving, from the offchain random oracle, a second random value associated with the second request identifier;
determining, based at least in part on mapping the second random value to a second function of return possibilities, a second return multiplier; and
determining, based at least in part on the second return multiplier and the second wager, the second return amount;
causing, based at least in part on the second return amount and the second game theme, rendering of a second set of visual characteristics different than the first set of visual characteristics including at least the second return amount on the second user device, wherein causing rendering of the second set of visual characteristics occurs offchain such that memory use by the blockchain network is reduced; and
updating, based at least in part on the second return amount, a second cryptocurrency balance associated with the second digital wallet of the second user of the second user device.

3. The system of claim 1, the operations further comprising associating a wallet address associated with the first user device with the first game theme.

4. The system of claim 1, wherein the terms defined by the published smart contract are based at least in part on parsing the set of rules associated with the first game theme to remove data unnecessary for determination of the return amount, the operations further comprising sending the terms defined by the published smart contract to a second node of the blockchain network for execution.

5. A method comprising:
receiving, from a first user, a first wager placed on a first game;
determining a return amount based at least part on rules defined by a smart contract stored on a node of a distributed ledger network, wherein the rules comprise:
sending a request for a random value to an off-network application;
receiving, from the off-network application, a random value;
determining, based at least in part on the random value, a multiplier; and
determining, based at least in part on the multiplier and the first wager, the return amount;
rendering a set of game characteristics associated with the first game to display at least the return amount to the first user; and
updating, based at least in part on the return amount, a balance associated with the first user.

6. The method of claim 5 wherein the rules are first rules and the smart contract is a first smart contract, further comprising:
receiving, from a second user, a second wager placed on a second game different than the first game;
determining a second return amount based at least part on second rules defined by a second smart contract on a second node of the distributed ledger network, wherein the second rules comprise;
sending a second request for a second random value to the off-network application;
receiving, from the off-network application, a second random value;
determining, based at least in part on the second random value, a second multiplier; and
determining, based at least in part on the second multiplier and the second wager, the second return amount;
rendering a set of game characteristics associated with the second game to display at least the second return amount to the second user; and
updating, based at least in part on the second return amount, a second balance associated with the second user.

7. The method of claim 5, further comprising associating a wallet address associated with the first user with an operator of the first game.

8. The method of claim 7, further comprising determining, based at least in part on sending a query associated with the wallet address to the distributed ledger network, that the balance associated with the wallet address meets or exceeds the first wager.

9. The method of claim 5, wherein the rules defined by the smart contract are based at least in part on parsing a set of rules associated with the first game to remove data unnecessary for determining of the return amount, further comprising:
sending the rules defined by the smart contract to a second node of the distributed ledger network for execution.

10. The method of claim 5, further comprising:
generating a machine learning model configured to generate as output at least a portion of data comprising the smart contract;
receiving feedback data indicating performance of the smart contract;
generating a training dataset from the feedback data;
training the machine learning model utilizing the training dataset such that a trained machine learning model is generated; and
determining, utilizing the trained machine learning model, an updated smart contract to be stored in association with the distributed ledger network.

11. The method of claim 5, wherein rendering the set of game characteristics associated with the first game occurs separate from the distributed ledger network such that memory use by the distributed ledger network is reduced.

12. The method of claim 5 wherein the first wager is associated with a first currency, further comprising converting the first currency into a second currency different than the first currency.

13. A system comprising:
one or more processors; and
a non-transitory memory storing processor-executable instructions that, when executed by the one or more processors, cause the one or more processors to perform operations comprising:
receiving, from a first user device, a first wager placed on a first game;
determining a return amount based at least part on rules defined by a smart contract stored on a node of a distributed ledger network, wherein the rules comprise:
sending a request for a random value to an off-network application;
receiving, from the off-network application, a random value;
determining, based at least in part on the random value, a multiplier; and
determining, based at least in part on the multiplier and the first wager, the return amount;
causing a set of game characteristics associated with the first game to render to display at least the return amount on the first user device; and
updating, based at least in part on the return amount, a balance associated with a user of the first user device.

14. The system of claim 13, wherein the rules are first rules and the smart contract is a first smart contract, the operations further comprising:
receiving, from a second user, a second wager placed on a second game different than the first game;
determining a second return amount based at least part on second rules defined by a second smart contract on a second node of the distributed ledger network, wherein the second rules comprise;
sending a second request for a second random value to the off-network application;
receiving, from the off-network application, a second random value;
determining, based at least in part on the second random value, a second multiplier; and
determining, based at least in part on the second multiplier and the second wager, the second return amount;
rendering a set of game characteristics associated with the second game to display at least the second return amount to the second user; and
updating, based at least in part on the second return amount, a second balance associated with the second user.

15. The system of claim 13, the operations further comprising associating a wallet address associated with a user of the first user device with an operator of the first game.

16. The system of claim 15, the operations further comprising determining, based at least in part on sending a query associated with the wallet address to the distributed ledger network, that the balance associated with the wallet address meets or exceeds the first wager.

17. The system of claim 13, wherein the rules defined by the smart contract are based at least in part on parsing a set of rules associated with the first game to remove data unnecessary for determining the return amount, the operations further comprising:
sending the rules defined by the smart contract to a second node of the distributed ledger network for execution.

18. The system of claim 13, the operations further comprising:
generating a machine learning model configured to generate as output at least a portion of data comprising the smart contract;
receiving feedback data indicating performance of the smart contract;
generating a training dataset from the feedback data;
training the machine learning model utilizing the training dataset such that a trained machine learning model is generated; and
determining, utilizing the trained machine learning model, an updated smart contract to be stored in association with the distributed ledger network.

19. The system of claim 13, wherein causing the set of game characteristics associated with the first game to render occurs separate from the distributed ledger network such that memory use of the distributed ledger network is reduced.

20. The system of claim 13 wherein the first wager is associated with a first currency, the operations further comprising converting the first currency into a second currency different than the first currency.
